(19) United States
(12) Patent Application Publication
(10) Pub. No.: US 2011/0079127 A1
(43) Pub. Date: Apr. 7, 2011

(54) Circular saw conversion table

(76) Inventors: Paul F. SOMOGYI, Clymer, PA (US); Kenneth R. ZIMMERMAN, Northern Cambria, PA (US)

(21) Appl. No.: 12/588,049

(22) Filed: Oct. 1, 2009

(51) Int. Cl. B26D 7/01

(52) U.S. Cl. 83/471.3

(57) ABSTRACT

The invention is directed toward a portable conversion table for a portable circular saw that facilitates conversion of commercial portable hand held circular saws into a table saw. It includes a work table with a working surface and a bottom surface clamping assembly which holds a portable circular saw, the table being provided with collapsible legs which permit the entire device to be broken down into a generally flat shape that can be easily transported.

### RELATED APPLICATIONS

There is no related application.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention is generally directed toward a conversation table for use in combination with a standard portable circular saw. In use, the combination approximates the functionality of a standard table saw but is sufficiently portable to be easily transported in a vehicle.

2. Background of the Invention

Portable power tools have long been available for use where their larger, shop-based versions would be impossible or otherwise impracticable to place into operation. Hence, for example, portable drills are used to perform many of the drilling tasks that are perhaps more easily completed using a drill press. Portable miter saws are available to perform some of the tasks a radial arm saw was previously used for, and portable circular saws are used in lieu of a standard table saw on jobsites or other locations where the conditions are not favorable for using the heavier duty tool. While these portable versions are handy, they generally suffer from a lack of precision. Conversely, while their larger, heavier-duty counterparts are much more precise, however their size and general heft make them unwieldy to transport and set up at a jobsite. What is needed therefore is a device that can essentially duplicate the function of the larger, bench-based devices while facilitating a degree of portability heretofore unavailable.

The prior art discloses a number of portable circular power hand saw benches or tables which allow conversion of a portable circular power saw into a table saw. U.S. Pat. No. 4,133,360 issued Jan. 9, 1979 shows a bench with foldable legs and a work surface which has a portable circular saw blade aperture cut there through with parallel and elongated narrow secondary slots. A tool holding frame is adjustably mounted on the upper work surface of the bench. U.S. Pat. No. 6,546,978 issued Apr. 15, 2003 discloses a two part portable table saw stand having a large folding table with a lower shelf which holds a portable table saw so that the table of the saw is flush with the top of the folding table. U.S. Pat. No. 4,204,446 issued May 27, 1980 is directed toward a work table and hold down assembly for a power hand saw and U.S. Pat. No. 4,252,239 issued Feb. 24, 1981 is directed toward a carpenter combination portable power operated hand saw and table saw. U.S. Design Pat. No. 379,275 issued May 20, 1997 is directed towards a foldable workbench.

### SUMMARY OF THE INVENTION

The present invention is directed toward a portable conversion table for a portable circular saw which facilitates conversion of all commercial hand held circular saws into a table saw. The conversion table is simple and ruggedly built to withstand the abuses inherent in its use. Collapsible legs permit the entire device to be broken down into a generally flat shape that can be easily transported in a vehicle trunk or similar compartment. In use, the device is simply erected by deploying a secondary articulating leg, then fixing the table at the desired height and/or inclination. Thereafter, a portable circular saw is mounted to the underside of the work table such that its blade projects upwards through the working surface of the work table. The circular saw is subsequently plugged into the device's safety switch for use as a table saw.

It is an object of the invention to produce a folding saw table that is easily transportable.

It is another object of the invention to produce a saw table which can easily accommodate different makes and models of circular saws allowing the same to be utilized as table saws.

It is still another object of the invention to produce a table which facilitates conversion of commercial hand held circular saw into a table saw in minutes.

It is yet another object of the invention to provide a table saw which is easy to transport by one person.

It is a further object of the invention to provide a table saw which stores compactly in a vehicle.

It is yet another object of the invention to provide a table saw which has safety features including a momentary pressure switch and a safety switch.

These and other objects, advantages, and novel features of the present invention will become apparent when considered with the teachings contained in the detailed disclosure along with the accompanying drawings.

### BRIEF DESCRIPTION OF THE DRAWINGS

FIG. 1 is a perspective view of the inventive table with legs extended and working surface tilted;

FIG. 2 is a perspective view of the table shown in FIG. 1 in a collapsed orientation, ready for stowage or transport;

FIG. 3 is a side perspective view of the table shown in FIGS. 1 and 2 fully erect and ready for the attachment of a portable circular saw;

FIG. 4 is a front perspective view of the table shown in FIGS. 1, 2, and 3 fully erect, showing its blade guard, and accessories including a miter guide and fence;

FIG. 5 is perspective view of the bottom surface of the work table;

FIG. 6 is a perspective view of the table surface shown in FIG. 5 with a portable circular saw mounted to the table;

FIG. 7 is a side perspective view of a section of the table shown in FIG. 6 and the portable circular saw;

FIG. 8 is a partial front perspective view of the table and portable circular saw shown in FIG. 6;

FIG. 9 is a side perspective view of the table ready for use, showing the blade of the portable circular saw projecting through its working surface, the blade guard, accessory fence and miter guide; and,

FIG. 10 is a perspective view of table in its collapsed orientation with the portable circular saw detached and the table stowed in a vehicle trunk.

### DESCRIPTION OF THE INVENTION

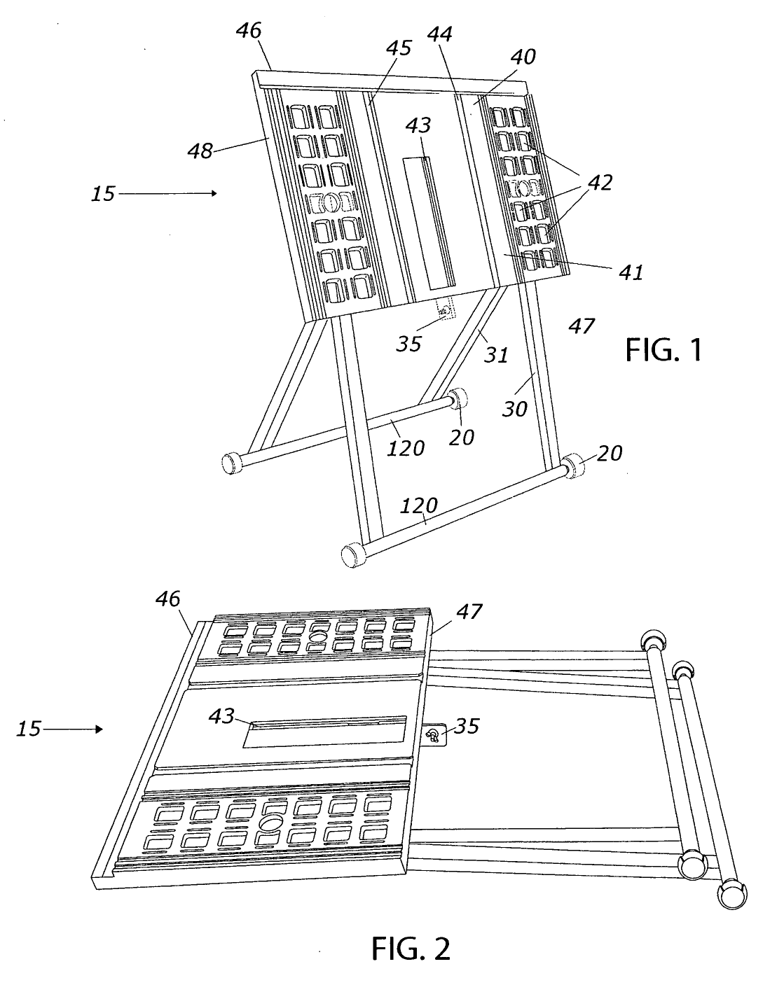

The present invention is directed towards a simple, ruggedly built, and robust conversion table allowing a portable circular saw to be mounted thereto and in combination function as a table saw. The preferred embodiments and best modes of the invention are shown in FIGS. 1 through 10. While the invention is described in connection with certain preferred embodiments, it is not intended that the present invention be so limited. On the contrary, it is intended to cover all alternatives, modifications, and equivalent arrangements as may be included within the spirit and scope of the invention as defined by the appended claims.

The invention may be constructed from any suitable material but in a preferred embodiment, is manufactured from metal such as steel, aluminum, various metal alloys, and combinations therein.

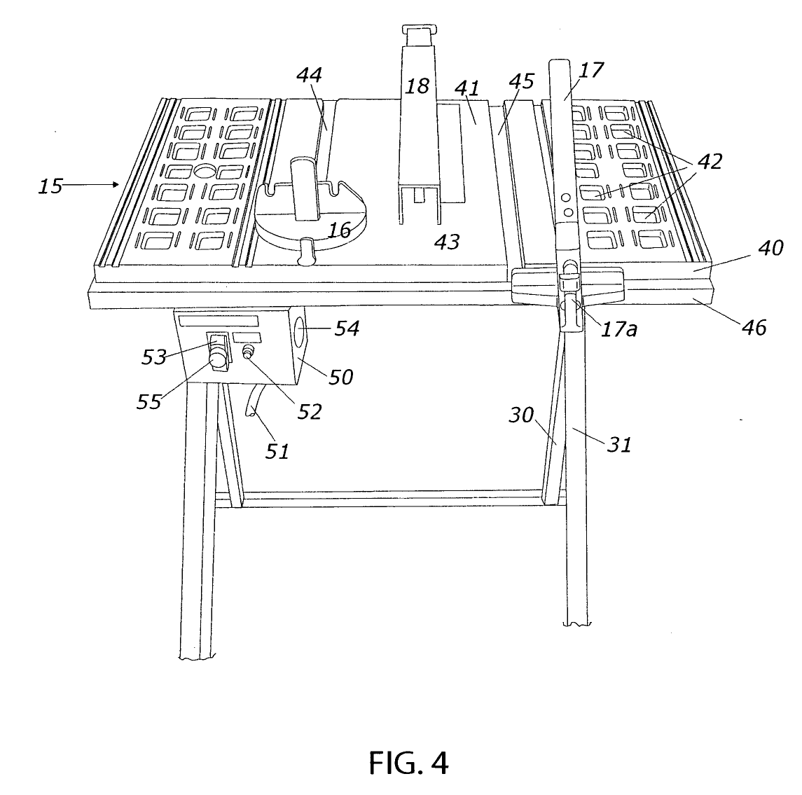

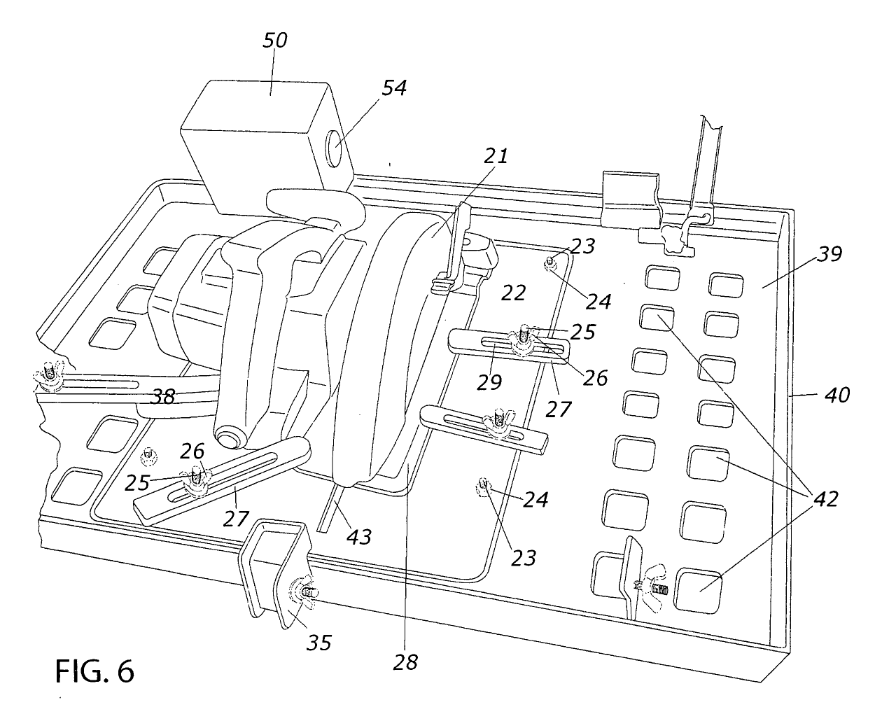

Turning now to FIGS. 1 and 2, the circular saw conversion table 15 is shown in partially erect (FIG. 1) and collapsed (FIG. 2) modes. Casters 20 are mounted to cross support members 120 which are in turn mounted to primary articulating legs 30 and secondary articulating legs 31 to facilitate moving the device, whether in its collapsed or its erect orientation. The generally planar, rectilinear work table 40 is designed to easily accommodate workpieces of any practicable size and in a preferred embodiment, measures approximately 26 inches along its long dimension and 18 inches along its shorter dimension and ranges from 27 inches to about 35 inches in height. In a preferred embodiment, it is cast from aluminum, and its working surface 41 is milled flat thereby ensuring the repeatable precision with regard to the cutting operations performed using this equipment. The work surface 41 additionally defines a plurality of apertures 42, commonly referred to as dog holes, which are provided at regularly spaced intervals at opposing ends of the work table 40. The holes 42 serve to both decrease the weight of the device 15, thereby making it more portable, and more importantly, permit the insertion of bench dogs (not shown) to facilitate the handling of larger workpieces. An elongate rectangular blade aperture 43 is formed in the work table 40 allowing the table 15 is used in conjunction with a mounted portable circular saw 21 as shown in FIGS. 6 through 9 to essentially duplicate the functionality of a standard table saw. The blade aperture 43 is sized to accommodate insertion of a portable circular saw blade but with sufficiently small tolerances relative to the kerf of the blade to minimize the likelihood that workpieces, parts thereof, or most catastrophically, the user's appendages will impinge operation of the blade. The blade aperture 43 is positioned substantially normal to the near end 46 and trailing end 47 of the work table 40 and substantially parallel to its sides 48. A first accessory slot 44 and second accessory slot 45 are positioned parallel to the blade aperture and accommodate various accessories that may be provided with the table 15. Additional accessory slots may be provided as desired, including additional slots parallel to and at varying distances from the circular saw blade, slots perpendicular to the circular saw blade, and slots at varying angles relative to the circular saw blade. The accessories are slidably mountable in the slots 44, 45 to thereby facilitate the precise and safe use of the table 15 and include, for example, a miter guide accessory 16 (FIG. 4) whereby a workpiece may be guided into the saw blade at a precise angle. In a preferred embodiment, the first and second accessory slots 44, 45 are spaced at differing distances from the blade aperture 43 in order to provide maximum flexibility in the use of the accessories. For example, the accessory miter guide 16 may be utilized in both slots 44, 45 in order to create compound miters for the workpiece. A blade guard mounting point 35 is provided adjacent the trailing end 47 whereby a blade guard 18 is provided to safeguard the user from flying debris, kickback of the workpiece (for example, due to hitting a knot in a piece of wood).

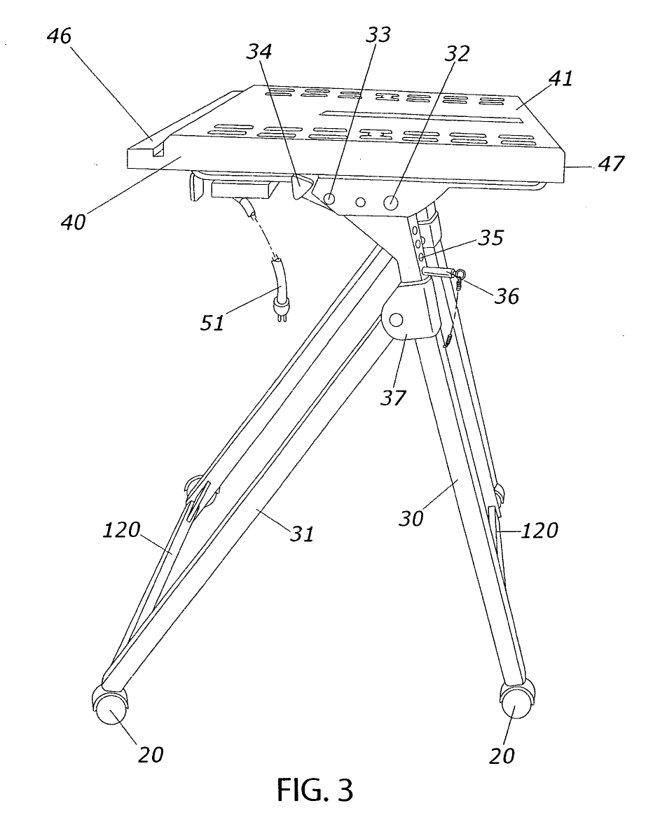

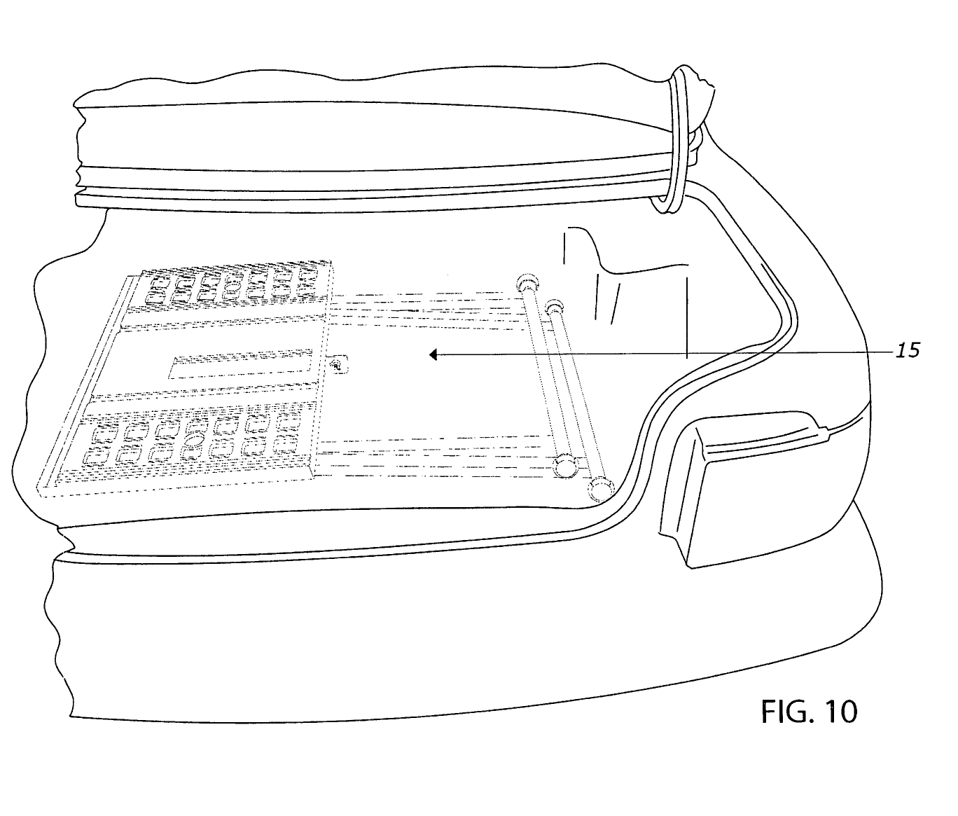

FIG. 3 shows a perspective side view of the inventive device including detail of the primary and secondary articulating legs 30, 31 comprising the support structure for the circular saw conversion table 15. In a preferred embodiment, the articulating legs 30, 31 are manufactured from steel square bar stock, although any suitably rigid yet lightweight material may be used, including other metals, and molded, extruded, or blow-molded polymers. The primary articulating legs 30 are hingedly mounted at a proximal end via hinge 32 to work table 40. Height adjustment sliders 37 are slidably mounted about the primary articulating legs 30 and are freely movable along the length of the legs 30. Secondary articulating legs 31 are rotatably mounted at their proximal end to the height adjustment sliders 37 allowing the secondary articulating legs 31 to be rotated substantially parallel to the primary articulating legs 30 for stowage and transport of the table 15 as can be seen in FIG. 10. In operation, the table 15 is erected by rotating the secondary articulating legs 31 away from the first articulating legs 30 wherein said secondary articulating legs are prevented from further extension by a stop (not shown) built into the height adjustment sliders 37. The height adjustment sliders 37 are then abutted against clevis pins 36 inserted into height adjustment holes 35 defined in the primary articulating legs 30 such that the mass of the work table 40 maintains the entire apparatus 15 in its erect position. The height adjustment holes 35 are placed such that the working height of the table ranges from about 27.5 inches to about 34.5 inches with the specific working heights preferably being 27½″, 29½″, 31¼″, 32¾″ and 34½″. However the height adjustment holes 35 may be placed at any position along the length of the primary articulating legs 30 according to the working height desired. Once erected to the desired working height, the work table 40 is then leveled (or tilted if so desired) using adjustment bolts 33 and locking thumbscrew 34.

FIG. 4 is a front perspective view of the inventive circular saw conversion table 15. An accessory miter guide 16, is shown placed in the first guide accessory slot 44, and a fence 17 used for facilitating ripping and cross-cutting operations is mounted via a hand lock 17a to table end 46. The blade guard 18 is shown positioned over the blade aperture 43. A switchbox 50 is mounted beneath and adjacent the near end 46 of the work table 40 and includes an electrically connected power cable 51, operational pressure switch 53, a resettable fuse 52, as well as a power plug receptacle 54. Optionally, an interlock device 55 may be incorporated into said operational switch 53 to prevent unauthorized use of the conversion table 15. In operation, the portable circular saw power plug (not shown) is simply plugged into the power plug receptacle 54 and the mounted portable circular saw is set for always-on operation by a trigger lock or other mechanism. Operation of the saw may then be controlled via the operational switch 53 thereby eliminating the danger that otherwise would be entailed by reaching beneath the table to trigger operation of the now-mounted portable circular saw. The resettable fuse 52 is provided to protect the portable circular saw motor from burning out in the event of an overload situation caused by a jammed workpiece.

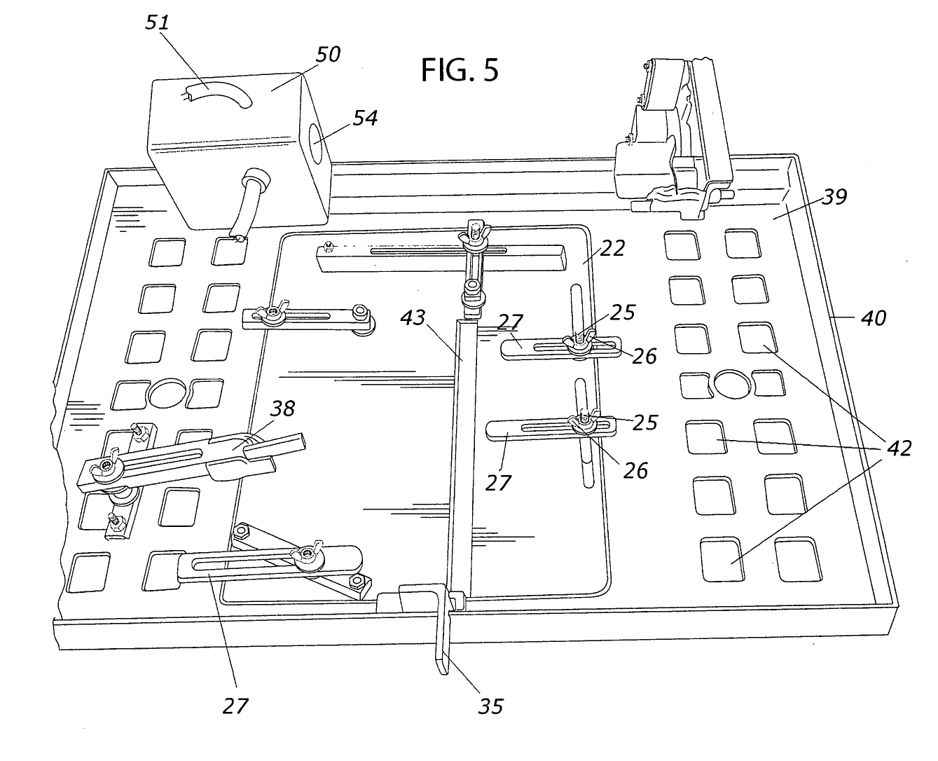

FIGS. 5 and 6 depict in perspective views the bottom surface of the work table 40, showing the portable circular saw mounting surface 39 prior to mounting the portable circular saw (FIG. 5) and with portable circular saw 21 mounted (FIG. 6). A generally rectangular mounting plate 22 is mounted to the mounting surface 39 via mounting plate attachment bolts 23 as shown in FIG. 6 affixed to the mounting surface 39 and mounting plate attachment nuts 24. The portable circular saw 21 is then mounted to the device 15 via clamping means which affix the saw 21 to the mounting plate 22. In a preferred embodiment, the mounting means include mounting clamp bolts 25 which are secured to the mounting plate 22 in a fixed position and clamp wing nuts 26 and an associated washer screwed on the bolts 25 with a plurality of universal mounting clamps 27. The universal mounting clamps 27 are utilized to clamp the circular saw's shoeplate 28 to the mounting plate 22. The universal mounting clamps 27 are generally elongate and may be manufactured from standard bar stock. An adjustment slot 29 is provided in each universal clamp member 27 facilitates mounting of an endless variety of commonly sold portable circular saws 21.

Mounting of a portable circular saw 21 is a simple operation, entailing removing the mounting plate 22 and affixing it to the portable circular saw shoeplate 28 with the universal mounting clamps 27, making sure that the mounting plate 22 and portable circular saw 21 are aligned relative to one another. The now-combined portable circular saw 21 and mounting plate 22 are then bolted to the tables mounting surface 39 using the attachment bolts 23 and associated attachment nuts 24. A secondary mounting clamp 38 directly mounted to the table is then utilized to further secure both the portable circular saw 21 and its mounting plate 22 to the mounting surface 39. Finally, the portable circular saw 21 is set for always-on operation, and its power plug (not shown) is plugged into the power plug receptacle 54. The device is now set upright, whereupon it is ready for use once it is plugged in. Since the saw was previously placed in its always-on mode, operation of the apparatus' operational switch 53 energizes the portable circular saw 21, causing its operation. This combination of the inventive portable circular saw conversion table 15 and now-mounted portable circular saw 21 is now operable to duplicate the function of a standard table saw, yet is extremely portable, being transportable in a vehicle trunk. Additionally, the mechanism by which the portable circular saw shoeplate 28 may be tilted in order to achieve certain cutting angles continues to be operable to cant the blade as desired even when mounted to the inventive table 15.

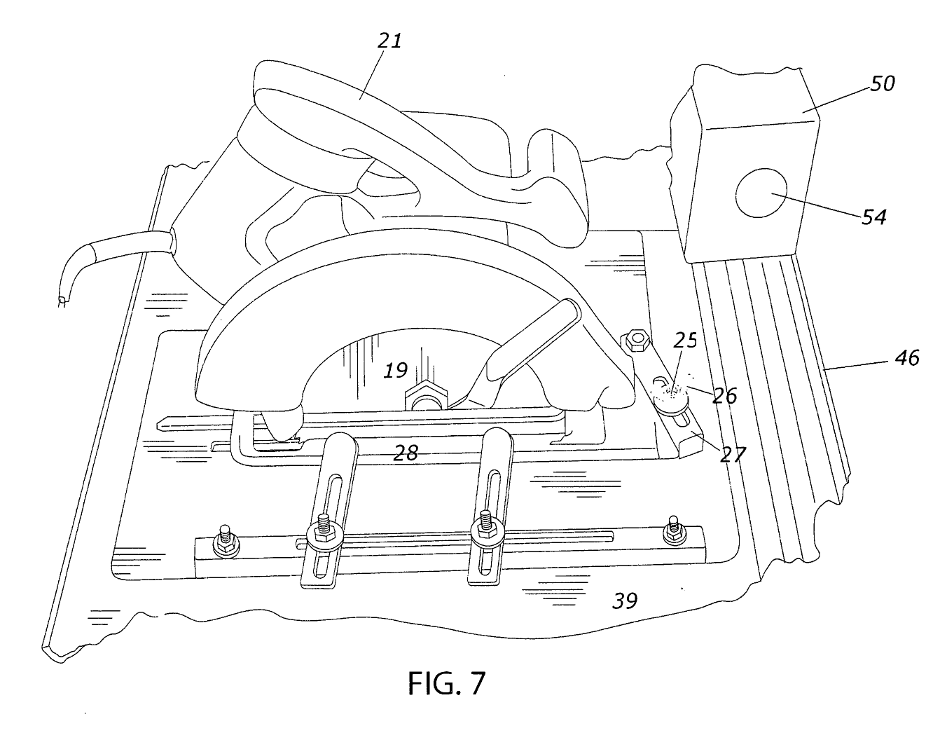

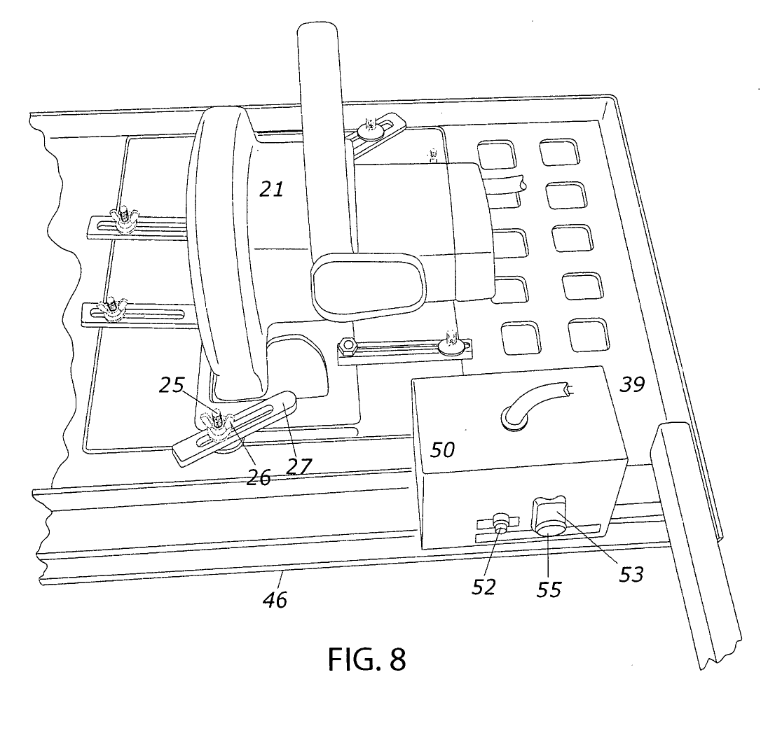

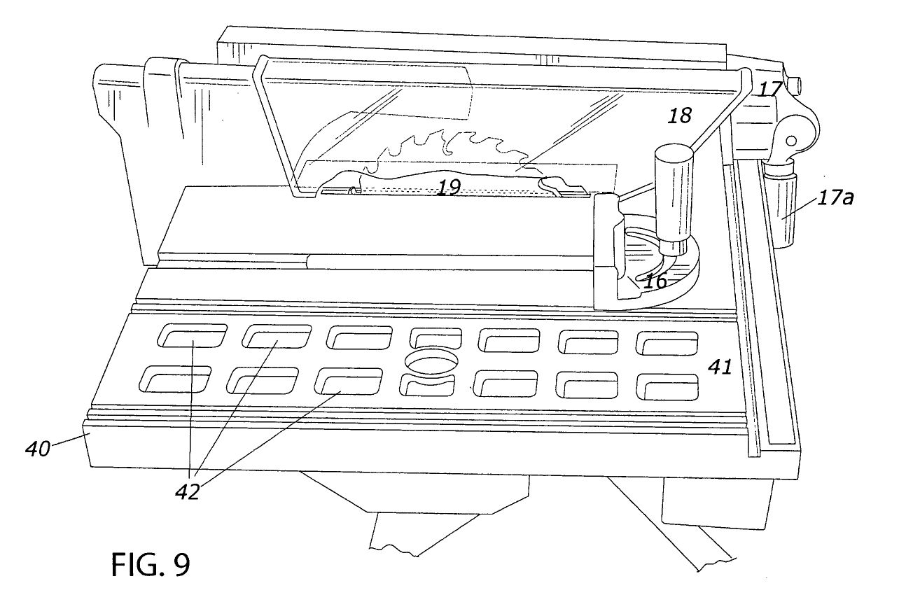

FIGS. 7 through 10 depict additional views of the table 15, including detailed alternative views of its reverse, showing the mounting surface 39 with portable circular saw 21 attached. FIG. 9 additionally shows the blade guard 18 in its operational position protecting the user from inadvertent contact with the saw blade 19. FIG. 10 depicts the inventive table 15 compactly stored for transport in a vehicle trunk.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A portable circular saw conversion table comprising:
a substantially rectilinear work table, said table defining a substantially planar working surface on its top surface and a mounting surface on its reverse surface;
an elongate blade aperture defined by said work table, said aperture being oriented normal to an end of said work table;
clamping means for mounting a portable circular saw to said mounting surface;
collapsible articulating legs affixed to said work table; and,
safety switching means operationally connectable to said portable circular saw.

2. A portable circular saw conversion table as claimed in claim 1 further comprising a plurality of dog hole apertures in said work table and at least one accessory slot.

3. A portable circular saw conversion table as claimed in claim 2 further comprising a miter guide slidably mountable in said at least one accessory slot.

4. A portable circular saw conversion table as claimed in claim 1 wherein said clamping means comprise a detachable mounting plate, the shoeplate of said portable circular saw being clampable to said mounting plate using elongate clamping bars removably mountable to said detachable mounting plate.

5. A portable circular saw conversion table as claimed in claim 1 wherein said safety switch means comprises an electrically connected power cable, an operational switch, a resettable fuse, and a power plug receptacle in electrical communication with one another.

6. A portable circular saw conversion table as claimed in claim 5 further comprising an interlock incorporated into said operational switch.

7. A portable circular saw conversion table as claimed in claim 1 wherein said work table is tiltable.

8. A portable circular saw conversion table as claimed in claim 1 wherein said collapsible articulating legs include height adjustment means for adjusting the work table height from about 27.5 inches to about 34.5 inches.

9. A portable circular saw conversion table as claimed in claim 8 wherein said collapsible articulating legs comprise primary articulating legs, and secondary articulating legs slidably mounted to said primary articulating legs, said secondary articulating legs being adjustably fixable via clevis pins to adjust the work table height.

10. A portable circular saw conversion table comprising:
a substantially rectilinear work table, said table defining a substantially planar working surface on its top surface and a mounting surface on its bottom surface;
an elongate blade aperture defined by said work table, said aperture being oriented normal to an end of said work table;
clamping means for mounting a portable circular saw to said mounting surface;
collapsible articulating legs affixed to said work table, said legs being provided with height adjustment means for adjusting the work table height from about 27.5 inches to about 34.5 inches; and,
safety switching means operationally connectable to said portable circular saw.

11. A portable circular saw conversion table as claimed in claim 10 further comprising a plurality of dog hole apertures in said work table and at least one accessory slot.

12. A portable circular saw conversion table as claimed in claim 11 further comprising a miter guide slidably mountable in said at least one accessory slot.

13. A portable circular saw conversion table as claimed in claim 10 wherein said clamping means comprise a detachable mounting plate, a shoeplate of said portable circular saw being clampable to said mounting plate using elongate clamping bars removably mountable to said detachable mounting plate.

14. A portable circular saw conversion table as claimed in claim 10 wherein said safety switch means comprises an electrically connected power cable, an operational switch, a resettable fuse, and a power plug receptacle in electrical communication with one another.

15. A portable circular saw conversion table as claimed in claim 14 further comprising an interlock incorporated into said operational switch.

16. A portable circular saw conversion table as claimed in claim 10 wherein said work table is tiltable.

17. A portable circular saw conversion table as claimed in claim 10 wherein said collapsible articulating legs comprise primary articulating legs, and secondary articulating legs slidably mounted to said primary articulating legs, said secondary articulating legs being adjustably fixable via clevis pins to adjust the work table height.

18. A portable circular saw conversion table as claimed in claim 10 wherein a blade guard is mounted to said table positioned over said blade aperture.

19. A portable circular saw conversion table comprising:
a substantially rectilinear work table, said table defining a substantially planar working surface on its top surface and a mounting surface on its reverse surface;
an elongate blade aperture defined by said work table, said aperture being oriented parallel to sides of said work table; a plurality of dog hole apertures formed in said work table and at least one accessory slot cut in said work table, a miter guide slidably mountable in said at least one accessory slot,
a detachable mounting plate removably mounted to said work table mounting surface, said mounting plate being adapted for mounting a portable circular saw to said mounting surface, the shoeplate of said portable circular saw being clampable to said mounting plate using elongate clamping bars removably mountable to said mounting plate;
collapsible articulating legs affixed to said work table having height adjustment means for adjusting the work table height from about 27.5 inches to about 34.5 inches; and,
an electrically connected power cable, operational switch, a resettable fuse, and power plug receptacle in electrical communication with one another.

20. A portable circular saw conversion table as claimed in claim 19 wherein a blade guard is mounted to said table positioned over said blade aperture.
